(19) United States
(12) Patent Application Publication
(10) Pub. No.: US 2024/0136862 A1
(43) Pub. Date: Apr. 25, 2024

(54) WIRELESS POWER TRANSMISSION DEVICE AND OPERATION METHOD THEREOF

(71) Applicant: Richtek Technology Corporation, Zhubei City (TW)

(72) Inventor: Fu-Chi LIN, Hsinchu City (TW)

(21) Appl. No.: 18/174,729

(22) Filed: Feb. 27, 2023

(30) Foreign Application Priority Data
Oct. 19, 2022 (TW) 111139818

(51) Int. Cl. H02J 50/60; H02J 50/80

(52) U.S. Cl. CPC H02J 50/60; H02J 50/80; H02J 50/10

(57) ABSTRACT

A wireless power transmission device includes a transmission device and a control device. The control device generates a driving signal to the transmission device in a first soft-start period, so as to drive the transmission device. The control device senses the current of the transmission device to obtain a current message, and determines whether a foreign object exists according the current message. When determining that the foreign object exists, the control device does not generate a carrier signal. When determining that the foreign object does not exist, the control device generates a carrier signal in a transmission period, and the carrier signal is output through the transmission device.

### CROSS REFERENCE TO RELATED APPLICATIONS

This application claims priority of Taiwan Patent Application No. 111139818, filed on Oct. 20, 2022, the entirety of which is incorporated by reference herein.

### BACKGROUND OF THE INVENTION

### Field of the Invention

The present invention relates to a transmission device, and in particular it relates to a wireless power transmission device and an operation method thereof.

### Description of the Related Art

In general, in a wireless power transmission system, a wireless power transmission terminal may provide a carrier to a wireless power receiving terminal, so that the wireless power receiving device may operate accordingly. However, since a foreign object may exist between the wireless power transmission terminal and the wireless power receiving terminal, it may cause the wireless power transmission terminal to generate a large inrush current that continuously heats the foreign object, causing the wireless power transmission terminal to malfunction or reset, or pose a hazard due to overheating.

Therefore, how to effectively determine whether a foreign object exists has become a focus for technical improvements by various manufacturers.

### BRIEF SUMMARY OF THE INVENTION

An embodiment of the present invention provides a wireless power transmission device and an operation method thereof, wherein it effectively determines whether a foreign object exists, and determines whether to provide the carrier signal according to whether a foreign object exists, so as to increase the safety and convenience of use.

An embodiment of the present invention provides a wireless power transmission device, which includes a transmission device and a control device. The control device generates a driving signal to the transmission device in a first soft-start period, so as to drive the transmission device. The control device senses the current of the transmission device to obtain a current message, and determines whether a foreign object exists according the current message. When determining that the foreign object exists, the control device does not generate a carrier signal. When determining that the foreign object does not exist, the control device generates the carrier signal in a transmission period, and the carrier signal is output through the transmission device.

An embodiment of the present invention provides an operation method of a wireless power transmission device, which includes the following steps. A driving signal is generated to the transmission device in a first soft-start period, so as to drive the transmission device. The current of the transmission device is sensed to obtain a current message. It is determined whether a foreign object exists according the current message. When determining that the foreign object exists, a carrier signal is not generated. When determining that the foreign object does not exist, the carrier signal is generated in a transmission period, and the carrier signal is output through the transmission device.

According to the wireless power transmission device and the operation method thereof disclosed by the present invention, the driving signal is generated to the transmission device in the first soft-start period, so as to drive the transmission device. The current of the transmission device is sensed to obtain the current message. It is determined whether the foreign object exists according the current message. When determining that the foreign object exists, the carrier signal is not generated. When determining that the foreign object does not exist, the carrier signal is generated in the transmission period, and the carrier signal is output through the transmission device. Therefore, it may effectively determine whether the foreign object exists, and whether to provide the carrier signal according to whether the foreign object exists, so as to increase the safety and the convenience of use.

### BRIEF DESCRIPTION OF THE DRAWINGS

The present invention can be more fully understood by reading the subsequent detailed description and examples with references made to the accompanying drawings, wherein:

FIG. 1 is a circuit diagram of a wireless power transmission device according an embodiment of the present invention;

FIG. 2A is a timing diagram of an operation of a wireless power transmission device according an embodiment of the present invention;

FIG. 2B is a timing diagram of an operation of a wireless power transmission device according another embodiment of the present invention;

FIG. 3A is a schematic view of a corresponding relationship and a time difference and an increase time of a current of a transmission device according an embodiment of the present invention;

FIG. 3B is a schematic view of a corresponding relationship and a time difference and an increase time of a current of a transmission device according another embodiment of the present invention;

FIG. 4 is a flowchart of an operation method of a wireless power transmission device according an embodiment of the present invention;

FIG. 5 is a detailed flowchart of step S406 in FIG. 4;

FIG. 6 is another detailed flowchart of step S406 in FIG. 4; and

FIG. 7 is a flowchart of an operation method of a wireless power transmission device according another embodiment of the present invention.

### DETAILED DESCRIPTION OF THE INVENTION

Technical terms of the present invention are based on general definition in the technical field of the present invention. If the present invention describes or explains one or some terms, definition of the terms is based on the description or explanation of the present invention. Each of the disclosed embodiments has one or more technical features. In possible implementation, a person skilled in the art would selectively implement all or some technical features of any embodiment of the present invention or selectively combine all or some technical features of the embodiments of the present invention.

In each of the following embodiments, the same reference number represents an element or component that is the same or similar.

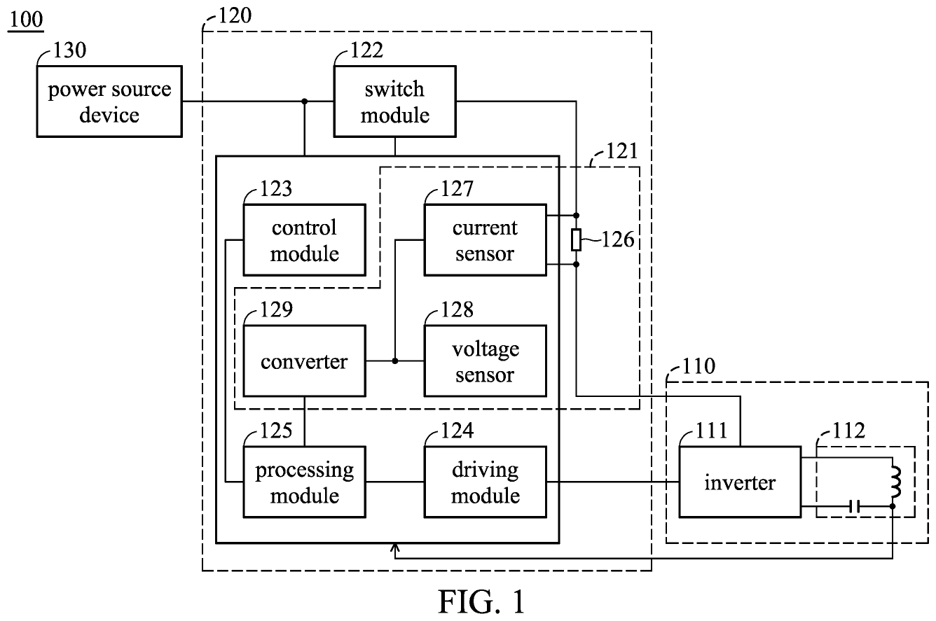

FIG. 1 is a circuit diagram of a wireless power transmission device according an embodiment of the present invention. Please refer to FIG. 1. The wireless power transmission device 100 may at least include a transmission device 110 and a control device 120.

The transmission device 110 may include an inverter 111 and a coil unit 112. In the embodiment, the inverter 111 is, for example, a half-bridge inverter or a full-bridge inverter, but the embodiment of the present invention is not limited thereto. The coil unit 112 may be coupled to the inverter 111 and transmit a carrier signal to a signal-receiving device (not shown). In the embodiment, the wireless power transmission device 100 may communicate with the signal-receiving device in a wireless manner, and transmit the carrier signal to the signal-receiving device through the coil unit 112 of the transmission device 110. In addition, the above carrier is, for example, a carrier signal with digital ping.

The control device 120 is coupled to the transmission device 110. Furthermore, the control device 120 may include a sensing module 121, a switch module 122, a control module 123, a driving module 124 and a processing module 125. The sensing module 121 is coupled to the transmission device 110, and senses an energy message of the transmission device, so as to generate a sensing message. The switch module 122 receives a power source signal. The control module 123 is coupled to the switch module 122, and controls the switch module 122, so as to turn on or turn off the switch module 122. In the embodiment, the control module 123 is, for example, a micro control unit. In addition, the driving module 124 is, for example, a pulse width modulator (PWM).

The processing module 125 is coupled to the sensing module 121, the control module 123 and the driving module 124. The processing module 125 may control the driving module 124 and the control module 123 to generate a driving signal to the transmission device 110, so as to drive the transmission device 110. The processing module 125 may determines whether a foreign object (not shown) exists according to the sensing message of the sensing module 121, and control the driving module 124 and the control module 123 to generate a carrier signal according to whether the foreign object exists. In the embodiment, the processing module 125 is, for example, a microprocessor. In addition, the above foreign object is, for example, an external foreign object or a metallic foreign object.

Furthermore, the sensing module 121 may include a sensing resistor 126, a current sensor 127, a voltage sensor 128 and a converter 129. The sensing resistor 126 is coupled between the switch module 122 and the inverter 111 of the transmission device 110. The current sensor 127 is coupled to the sensing resistor 126, and senses a current flowing through the sensing resistor 126 (i.e., the current of the inverter 111 of the transmission device 110), so as to generate a current message of the energy message.

The voltage sensor 128 is coupled to the coil unit 112 of the transmission device 110, and senses a voltage of the coil unit 112, so as to generate a voltage message of the energy message. The converter 129 is coupled to the current sensor 127, the voltage sensor 128 and the processing module 125, receives the current message and the voltage message, and provides the current message and the voltage message to the processing module 125, so that the processing module 125 may determine whether a foreign object exists accordingly. In the embodiment, the converter 129 is, for example, an analog-to-digital converter (ADC). In addition, the wireless power transmission device 100 further include a power source device 130. The power source device 130 is coupled to the switch module 122, the control module 123, the driving module 124 and the processing module 125, and provides the power source signal.

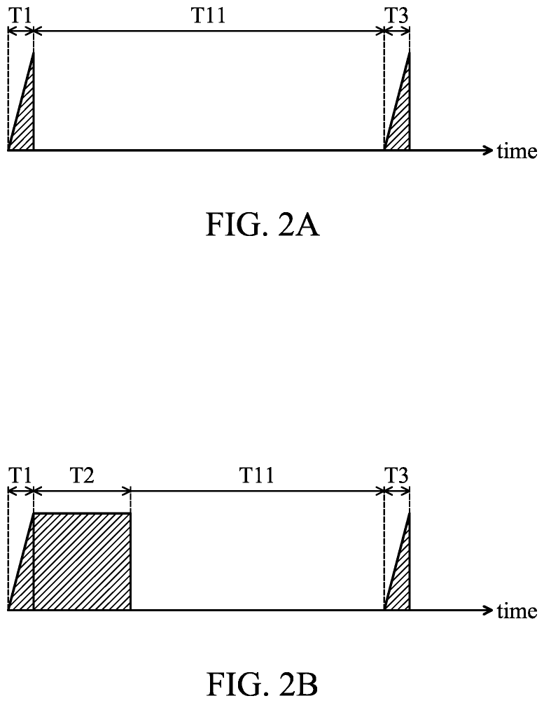

The internal components and the coupling relationship thereof of the wireless power transmission device 100, and an operation of the wireless power transmission device 100 will be described below with a timing diagram. FIG. 2A is a timing diagram of an operation of a wireless power transmission device according an embodiment of the present invention. FIG. 2B is a timing diagram of an operation of a wireless power transmission device according another embodiment of the present invention.

Please refer to FIG. 1 and FIG. 2A or FIG. 2B. In a first soft-start period T1, the control device 120 may generate the driving signal to the transmission device 110, so as to drive the transmission device 110. That is, the processing module 125 may control the driving module 124 and the control module 123, so as to generate the driving signal to the transmission device 110.

Then, during the first soft-start period T1, the control device 120 may sense the current of the transmission device 110 to obtain the current message, and determines whether the foreign object exists according to the current message, i.e., it is determined whether the foreign object approach the wireless power transmission device 100.

For example, in some embodiments, after the control device 120 obtains the current message, the control device 120 may determine whether the current of the transmission device 110 in the current message has reached a predetermined current value. That is, when a foreign object exists and approaches the wireless power transmission device 100, the transmission device 110 may induce the foreign object, and the current of the transmission device 110 may increase rapidly. When determining that the current has reached the predetermined current value, the control device 120 determines that the foreign object exists, which indicates that the foreign object is approaching the wireless power transmission device 100. When determining that the current has not reached the predetermined current value, the control device 120 determines that the foreign object does not exist, which indicates that the foreign object does not approach the wireless power transmission device 100.

In addition, in some embodiments, after the control device 120 obtains the current message, the control device 120 may determine whether the current of the transmission device 110 in the current message has reached a predetermined current value. That is, when a foreign object exists and approaches the wireless power transmission device 100, the transmission device 110 may induce the foreign object and the current of the transmission device 110 may increase rapidly.

When determining that the current has not reached the predetermined current value, the control device 120 determines that the foreign object does not exist, which indicates that the foreign object does not approach the wireless power transmission device 100. When determining that the current has reached the predetermined current value, the control device 120 may obtain a time value that the current has reached the predetermined current value. Then, the control device 120 may compare the above time value with a predetermined time value, so as to determine whether the time value is less than the predetermined time value. That is, when the foreign object exists and approaches the wireless power transmission device 100, the transmission device 110 may induce the foreign object and the current of the transmission device 110 may increase rapidly, causing the current of the transmission device 110 to reach the predetermined current value earlier than the predetermined time value.

When determining that the time value is less than the predetermined current value, the control device 120 may determine that the foreign object exists, which indicates that the foreign object is approaching the wireless power transmission device 100. When determining that the time value is not less than the predetermined time value, the control device 120 may determine that the foreign object does not exist, which indicates that the foreign object is not approaching the wireless power transmission device 100.

Then, when determining that the foreign object exists, the control device 120 may not generate the carrier signal, as shown in FIG. 2A. When determining that the foreign object does not exist, the control device 120 may generate the carrier signal in the transmission period T2, and the carrier signal may be output through the transmission device 110, as shown in FIG. 2B. In the embodiment, the first soft-start period T1 is, for example, less than the transmission period T2. For example, the first soft-start period T1 may be less than or equal to ⅕ of the transmission period T2 (i.e., T1≤(1/5)*T2), and the transmission T2 is, for example, 70 milliseconds (ms)˜90 milliseconds, but the embodiment of the present invention is not limited thereto.

In addition, after the control device 120 generates the carrier signal in the transmission T2, the control device 120 may detect whether there is a response message from a signal-receiving device through the transmission device 110, wherein the response message is generated by the signal-receiving device in response to the carrier signal. That is, the control device 120 may detect whether the signal-receiving device is adjacent to the transmission device 110 (the wireless power transmission device 100) or far away from the transmission device 110 (the wireless power transmission device 100).

When the control device 120 detects that there is the response message, it indicates that the signal-receiving device is adjacent to the transmission device 110 (the wireless power transmission device 100), and the control device 120 may continuously provide the carrier signal, so as to maintain the operation of the signal-receiving device. When the control device 120 detects that there is no response message, it indicates that the signal-receiving device is far away from the transmission device 110 (the wireless power transmission device 100), and the control device 120 may stop providing the carrier signal.

After the control device 120 may not generate the carrier signal, or stop providing the carrier signal, the control device 120 may generate the driving signal to the transmission device 110 in a second soft-start period T3, so as to drive the transmission device 110. The control device 120 may then detect again whether the foreign object exists, and determine whether to provide the carrier signal according to whether the foreign object exists. In addition, the operating manner of the second soft-start period T3 is the same as or similar to the operating manner of the first soft-start period T1. Accordingly, the operating manner of the second soft-start period T3 may be inferred from the description of the embodiment of the first soft-start period T1, and the description thereof is not repeated herein.

In the embodiment, there is a time difference T11 between the start position of the second soft-start period T3 and the end position of the first soft-start period T1 and the end position of the transmission period T2, as shown in FIG. 2A or FIG. 2B. In some embodiments, the value for the time difference T11 cited above may be different; for example, it may be according to whether the foreign object exists or not. Specifically, when the control device 120 determines that the foreign object exists, the control device 120 may set a longer time difference T11. When the control device 120 determines that the foreign object does not exist, the control device 120 may set a shorter time difference T11.

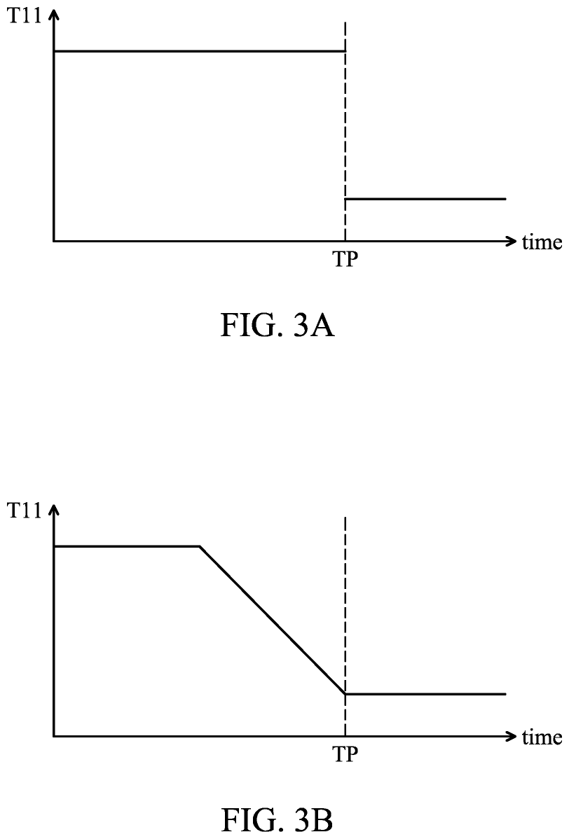

In some embodiments, a magnitude of the time difference T11 is related to a sensing time of the current of the transmission device 110, for example. As shown in FIG. 3A, before the sensing time of the current of the transmission device 110 has reached the predetermined time value TP, when the control device 120 determines that the current of the transmission device 110 has reached the predetermined current value, the control device 120 may set a longer time difference T11. After the sensing time of the current of the transmission device 110 has reached the predetermined time value TP, when the control device 120 determines that the current of the transmission device 110 has not reached the predetermined current value, the control device 120 may set a shorter time difference T11.

As shown in FIG. 3B, before the sensing time of the current of the transmission device 110 has reached the predetermined time value TP, when the control device 120 determines that the current of the transmission device 110 has reached the predetermined current value, the control device 120 may set a longer time difference T11. In addition, before the predetermined time value TP, when the control device 120 determines that the current of the transmission device 110 has reached the predetermined current value, the magnitude of the time difference T11 may be inversely proportional to the magnitude of the sensing time.

That is, when the sensing time that the current of the transmission device 110 has reached the predetermined current value is shorter, the control device 120 may set a longer time difference T11. When the sensing time that the current of the transmission device 110 has reached the predetermined current value is longer, the control device 120 may set a shorter time difference T11. After the sensing time of the current of the transmission device 110 has reached the predetermined time value TP, when the control device 120 has determined that the current of the transmission device 110 has not reached the predetermined current value, the control device 120 may set a shorter time difference T11.

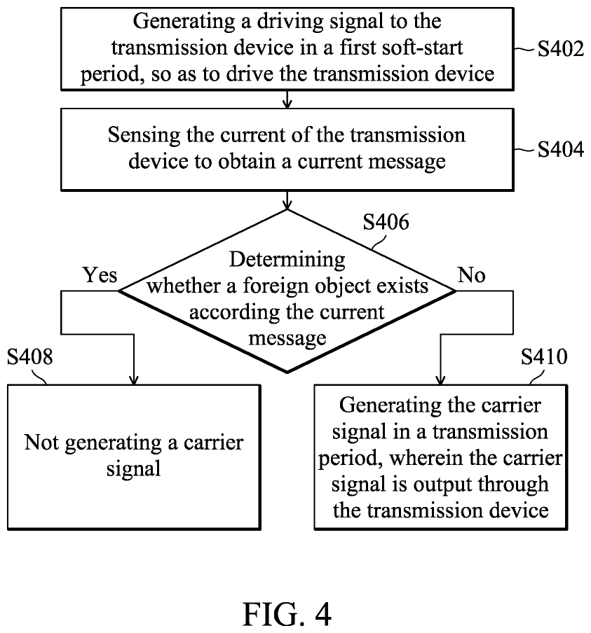

FIG. 4 is a flowchart of an operation method of a wireless power transmission device according an embodiment of the present invention. In step S402, the method involves generating a driving signal to the transmission device in a first soft-start period, so as to drive the transmission device. In step S404, the method involves sensing the current of the transmission device to obtain a current message. In step S406, the method involves determining whether a foreign object exists according the current message.

When determining that the foreign object exists, the method performs step S408. In step S408, the method involves not generating a carrier signal. When determining that the foreign object does not exist, the method performs step S410. In step S410, the method involves generating the carrier signal in a transmission period, wherein the carrier signal is output through the transmission device. In some embodiments, the foreign object is, for example, an external foreign object or a metallic foreign object. In addition, the first soft-start period is, for example, less than the transmission period.

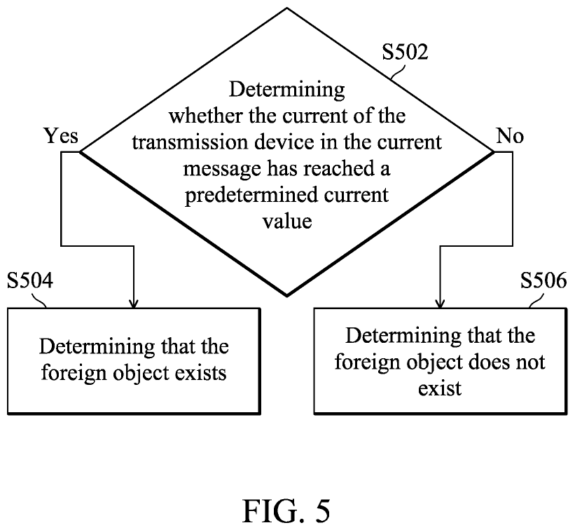

FIG. 5 is a detailed flowchart of step S406 in FIG. 4. In step S502, the method involves determining whether the current of the transmission device in the current message has reached a predetermined current value. When determining that the current has reached the predetermined current value, the method performs step S504. In step S504, the method involves determining that the foreign object exists. When determining that the current has not reached the predetermined current value, the method performs step S506. In step S506, the method involves determining that the foreign object does not exist.

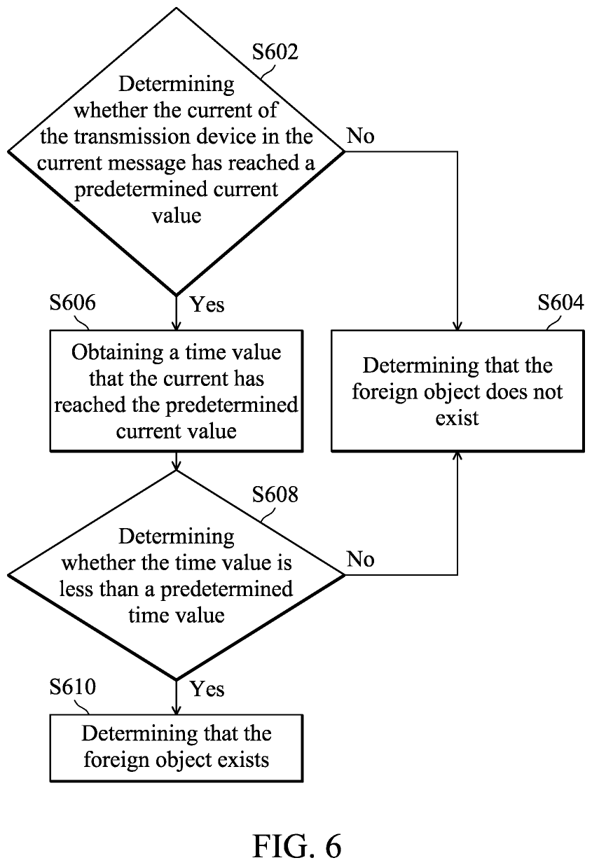

FIG. 6 is another detailed flowchart of step S406 in FIG. 4. In step S602, the method involves determining whether the current of the transmission device in the current message has reached a predetermined current value. When determining that the current has not reached the predetermined current value, the method performs step S604. In step S604, the method involves determining that the foreign object does not exist. When determining that the current has reached the predetermined current value, the method performs step S606. In step S606, the method involves obtaining a time value that the current has reached the predetermined current value. In step S608, the method involves determining whether the time value is less than a predetermined time value. When determining that the time value is less than the predetermined time value, the method performs step S610. In step S610, the method involves determining that the foreign object exists. When determining that the time value is not less than the predetermined time value, the method performs step S604. In step S604, the method involves determining that the foreign object does not exist.

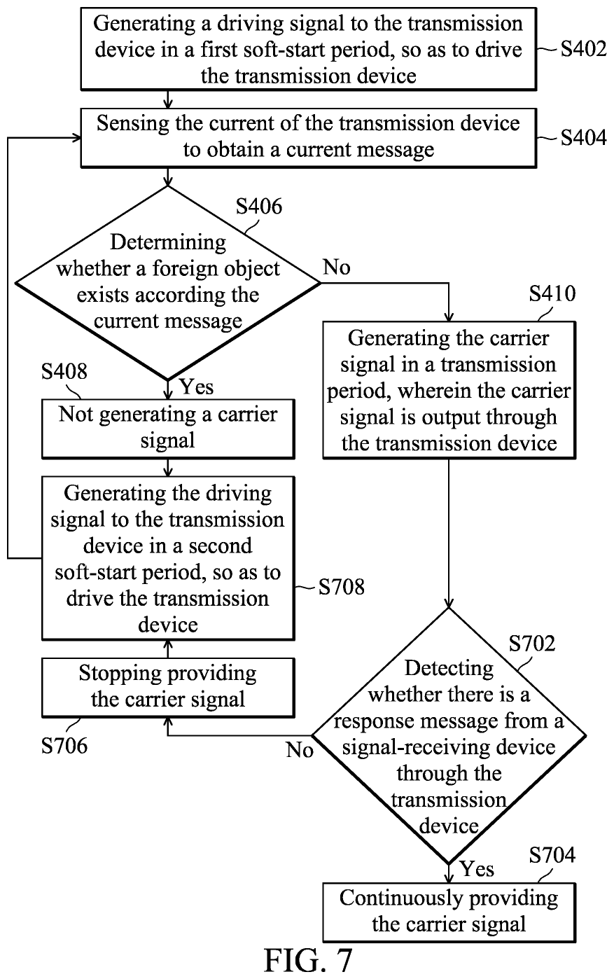

FIG. 7 is a flowchart of an operation method of a wireless power transmission device according another embodiment of the present invention. In the embodiment, steps S402˜S410 in FIG. 7 are the same as or similar to steps S402˜S410 in FIG. 4. Accordingly, steps S402˜S410 in FIG. 7 may be inferred from the description of the embodiment of FIG. 4, and the description thereof is not repeated herein.

In step S702, the method involves detecting whether there is a response message from a signal-receiving device through the transmission device, wherein the response message is generated by the signal-receiving device in response to the carrier signal. When detecting that there is the response message, the method performs step S704. In step S704, the method involves continuously providing the carrier signal. When detecting that there is no response message, the method performs step S706. In step S706, the method involves stopping providing the carrier signal.

Following step S408 and step S706, in step S708, the method involves generating the driving signal to the transmission device in a second soft-start period, so as to drive the transmission device. Then, step S404 is performed to determine whether the foreign object exists again. In the embodiment, there is a time difference between the start position of the second soft-start period and the end position of the first soft-start period or the end position of the transmission period. In some embodiments, the time difference is different according to whether the foreign object exists or not, for example. Specifically, when the foreign object exists, the time difference may be, for example, longer, and when the foreign object does not exist, the time difference may be, for example, shorter.

In summary, according to the wireless power transmission device and the operation method thereof disclosed by the embodiment of the present invention, the driving signal is generated to the transmission device in the first soft-start period, so as to drive the transmission device. The current of the transmission device is sensed to obtain the current message. It is determined whether the foreign object exists according the current message. When determining that the foreign object exists, the carrier signal is not generated. When determining that the foreign object does not exist, the carrier signal is generated in the transmission period, and the carrier signal is output through the transmission device. Therefore, it may effectively determine whether the foreign object exists, and determine whether to provide the carrier signal according to whether the foreign object exists, so as to increase the safety and the convenience of use.

While the present invention has been described by way of example and in terms of the preferred embodiments, it should be understood that the present invention is not limited to the disclosed embodiments. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A wireless power transmission device, comprising:
a transmission device; and
a control device, wherein the control device generates a driving signal to the transmission device in a first soft-start period, so as to drive the transmission device, the control device senses a current of the transmission device to obtain a current message, and determines whether a foreign object exists according the current message, wherein when determining that the foreign object exists, the control device does not generate a carrier signal, and when determining that the foreign object does not exist, the control device generates the carrier signal in a transmission period, and the carrier signal is output through the transmission device.

2. The wireless power transmission device as claimed in claim 1, wherein the foreign object is an external foreign object or a metallic foreign object.

3. The wireless power transmission device as claimed in claim 1, wherein the control device determines whether the current of the transmission device in the current message has reached a predetermined current value, wherein when determining that the current has reached the predetermined current value, the control device determines that the foreign object exists, and when determining that the current has not reached the predetermined current value, the control device determines that the foreign object does not exist.

4. The wireless power transmission device as claimed in claim 1, wherein the control device determines whether the current of the transmission device in the current message has reached a predetermined current value, wherein when determining that the current has not reached the predetermined current value, the control device determines that the foreign object does not exist, when determining that the current has reached the predetermined current value, the control device obtains a time value that the current has reached the predetermined current value, the control device determines whether the time value is less than a predetermined time value, when determining that the time value is less than the predetermined time value, the control device determines that the foreign object exists, and when determining that the time value is not less than the predetermined time value, the control device determines that the foreign object does not exist.

5. The wireless power transmission device as claimed in claim 1, wherein the control device further generates the driving signal to the transmission device in a second soft-start period, so as to drive the transmission device, wherein there is a time difference between a start position of the second soft-start period and an end position of the first soft-start period or an end position of the transmission period.

6. The wireless power transmission device as claimed in claim 5, wherein the time difference is different according to whether the foreign object exists or not.

7. The wireless power transmission device as claimed in claim 6, wherein when the foreign object exists, the time difference is longer, and when the foreign object does not exist, the time difference is shorter.

8. The wireless power transmission device as claimed in claim 5, wherein a magnitude of the time difference is related to a sensing time of the current of the transmission device.

9. The wireless power transmission device as claimed in claim 1, wherein the control device further detects whether there is a response message from a signal-receiving device through the transmission device, wherein when the control device detects that there is the response message, the control device continuously provides the carrier signal, and when the control device detects that there is no response message, the control device stops providing the carrier signal, wherein the response message is generated by the signal-receiving device in response to the carrier signal.

10. The wireless power transmission device as claimed in claim 1, wherein the first soft-start period is shorter than the transmission period.

11. An operation method of a wireless power transmission device, comprising:
generating a driving signal to the transmission device in a first soft-start period, so as to drive the transmission device;
sensing a current of the transmission device to obtain a current message;
determining whether a foreign object exists according the current message;
when determining that the foreign object exists, not generating a carrier signal; and
when determining that the foreign object does not exist, generating the carrier signal in a transmission period, wherein the carrier signal is output through the transmission device.

12. The operation method of the wireless power transmission device as claimed in claim 11, wherein the foreign object is an external foreign object or a metallic foreign object.

13. The operation method of the wireless power transmission device as claimed in claim 11, wherein step of determining whether a foreign object exists according the current message comprises:
determining whether the current of the transmission device in the current message has reached a predetermined current value;
when determining that the current has reached the predetermined current value, determining that the foreign object exists; and
when determining that the current has not reached the predetermined current value, determining that the foreign object does not exist.

14. The operation method of the wireless power transmission device as claimed in claim 11, wherein step of determining whether a foreign object exists according the current message comprises:
determining whether the current of the transmission device in the current message has reached a predetermined current value;
when determining that the current has not reached the predetermined current value, determining that the foreign object does not exist;
when determining that the current has reached the predetermined current value, obtaining a time value that the current has reached the predetermined current value;
determining whether the time value is less than a predetermined time value;
when determining that the time value is less than the predetermined time value, determining that the foreign object exists; and
when determining that the time value is not less than the predetermined time value, determining that the foreign object does not exist.

15. The operation method of the wireless power transmission device as claimed in claim 11, further comprising:
generating the driving signal to the transmission device in a second soft-start period, so as to drive the transmission device;
wherein there is a time difference between a start position of the second soft-start period and an end position of the first soft-start period or an end position of the transmission period.

16. The operation method of the wireless power transmission device as claimed in claim 15, wherein the time difference is different according to whether the foreign object exists or not.

17. The operation method of the wireless power transmission device as claimed in claim 16, wherein when the foreign object exists, the time difference is longer, and when the foreign object does not exist, the time difference is shorter.

18. The operation method of the wireless power transmission device as claimed in claim 16, wherein a magnitude of the time difference is related to a sensing time of the current of the transmission device.

19. The operation method of the wireless power transmission device as claimed in claim 11, further comprising:
detecting whether there is a response message from a signal-receiving device through the transmission device, wherein the response message is generated by the signal-receiving device in response to the carrier signal;
when detecting that there is the response message, continuously providing the carrier signal; and
when detecting that there is no response message, stopping providing the carrier signal.

20. The operation method of the wireless power transmission device as claimed in claim 11, wherein the first soft-start period is shorter than the transmission period.
